(19) United States
(12) Patent Application Publication
(10) Pub. No.: US 2014/0279944 A1
(43) Pub. Date: Sep. 18, 2014

(54) SQL QUERY TO TRIGGER TRANSLATION FOR MAINTAINING CONSISTENCY OF CACHE AUGMENTED SQL SYSTEMS

(71) Applicants: Shahram Ghandeharizadeh, Los Angeles, CA (US); Jason Yap, Rancho Palos Verdes, CA (US)

(72) Inventors: Shahram Ghandeharizadeh, Los Angeles, CA (US); Jason Yap, Rancho Palos Verdes, CA (US)

(73) Assignee: UNIVERSITY OF SOUTHERN CALIFORNIA, Los Angeles, CA (US)

(21) Appl. No.: 14/209,619

(22) Filed: Mar. 13, 2014

Related U.S. Application Data
(60) Provisional application No. 61/800,321, filed on Mar. 15, 2013.
(60) Provisional application No. 61/907,066, filed on Nov. 21, 2013.

(51) Int. Cl. G06F 17/30

(52) U.S. Cl. CPC G06F 17/30371
USPC 707/690

(57) ABSTRACT

An SQL query-to-procedure translation system may be used in connection with a relational database management system (RDBMS) that is augmented by a cache and a cache management system that manages the cache. The query-to-procedure translation system may include a data processing system that has at least one computer hardware processor and a configuration that, in response to a query issued by an application program for data from the relational database management system: intercepts the query; generates code that determines if data requested by the query that may be in the cache has changed; and registers the code as a procedure with the RDBMS.

### CROSS-REFERENCE TO RELATED APPLICATIONS

This application is based upon and claims priority to U.S. provisional patent application 61/800,321, entitled “SQL Query to Trigger Translation: A Novel Consistency Technique for Cache Augmented SQL Systems,” filed Mar. 15, 2013, attorney docket number 028080-0874, and to U.S. provisional patent application 61/907,066, entitled “Client Enhanced Wrappers for Database Management Systems,” filed Nov. 21, 2013, attorney docket number 028080-0952. The entire content of these applications is incorporated herein by reference.

### BACKGROUND

1. Technical Field

This disclosure relates to relational database management systems (RDBMS) that are augmented by a cache and to cache management systems that manage these caches.

2. Description of Related Art

Middle-tier caches can complement a relational database management system (RDBMS) to enhance overall system performance. See A. lyengar and J. Challenger, “Improving Web Server Performance by Caching Dynamic Data”, In In Proceedings of the USENIX Symposium on Internet Technologies and Systems, pages 49-60, 1997; J. Challenger, P. Dantzig, and A. lyengar, “A Scalable System for Consistently Caching Dynamic Web Data”, In IEEE Computer and Communications Societies, 1999; K. Yagoub, D. Florescu, V. Issarny, and P. Valduriez, “Caching Strategies for Data-Intensive Web Sites”, In VLDB, pages 188-199, 2000; L. Degenaro, A. lyengar, I. Lipkind, and I. Rouvellou, “A Middleware System Which Intelligently Caches Query Results”, In IFIP/ACM International Conference on Distributed systems platforms, 2000; A. Datta, K. Dutta, H. Thomas, D. VanderMeer, D. VanderMeer, K. Ramamritham, and D. Fishman, “A Comparative Study of Alternative Middle Tier Caching Solutions to Support DynamicWeb Content Acceleration”, In VLDB, pages 667-670, 2001; K. S. Candan, W. Li, Q. Luo, W. Hsiung, and D. Agrawal, “Enabling Dynamic Content Caching for Database-Driven Web Sites”, In SIGMOD, pages 532-543, 2001; Q. Luo, S. Krishnamurthy, C. Mohan, H. Pirahesh, H. Woo, B. G. Lindsay, and J. F. Naughton, “Middle-Tier Database Caching for e-Business”, In SIGMOD, 2002; A. Labrinidis and N. Roussopoulos, “Exploring the Tradeoff Between Performance and Data Freshness in Database-Driven Web Servers”, The VLDB Journal, 2004; M. Altinel, C. Bornhövd, S. Krishnamurthy, C. Mohan, H. Pirahesh, and B. Reinwald, “Cache Tables: Paving the Way for an Adaptive Database Cache”, In VLDB, 2003; “The TimesTen Team. Mid-Tier Caching: The TimesTen Approach”, In SIGMOD, 2002; P. Larson, J. Goldstein, and J. Zhou, “MTCache: Transparent Mid-Tier Database Caching in SQL Server”, In ICDE, pages 177-189, 2004; C. Bornhövdd, M. Altinel, C. Mohan, H. Pirahesh, and B. Reinwald, “Adaptive Database Caching with DBCache”, IEEE Data Engineering Bull., pages 11-18, 2004; A. Datta, K. Dutta, H. M. Thomas, D. E. VanderMeer, and K. Ramamritham, “Proxy-based Acceleration of Dynamically Generated Content on the World Wide Web: An Approach and Implementation”, ACM Transactions on Database Systems, pages 403-443, 2004; K. Amiri, S. Park, and R. Tewari, “DBProxy: A Dynamic Data Cache for Web Applications”; In ICDE, 2003; C. Amza, A. L. Cox, and W. Zwaenepoel, “A Comparative Evaluation of Transparent Scaling Techniques for Dynamic Content Servers”, In ICDE, 2005; C. Amza, G. Soundararajan, and E. Cecchet, “Transparent Caching with Strong Consistency in Dynamic Content Web Sites”, In Supercomputing, ICS '05, pages 264-273, New York, N.Y., USA, 2005, ACM; D. R. K. Ports, A. T. Clements, I. Zhang, S. Madden, and B. Liskov, “Transactional consistency and automatic management in an application data cache”, In OSDI. USENIX, October 2010; P. Gupta, N. Zeldovich, and S. Madden, “A Trigger-Based Middleware Cache for ORMs”, In Middleware, 2011.

The cache manager may be a key-value store (KVS), storing and retrieving key-value pairs computed using the normalized relational data. The resulting cache augmented SQL RDBMSs (CASQL) may be useful for scaling database driven web applications by reducing the load imposed on both the RDBMS and the application servers, see S. Ghandeharizadeh and J. Yap. “Cache Augmented Database Management Systems”. ACM SIGMOD 2013 Workshop—DBSocial, June 2013; R. Nishtala, H. Fugal, S. Grimm, M. Kwiatkowski, H. Lee, H. C. Li, R. Mcelroy, M. Paleczny, D. Peek, P. Saab, D. Stafford, T. Tung, and V. Venkataramani, “Scaling Memcache at Facebook”, in NSDI 2013. They may extend existing SQL deployments and may enhance the performance of workloads with a high read to write ratio significantly. One in-memory KVS is memcached which is used by web destinations such as Facebook. See R. Nishtala, H. Fugal, S. Grimm, M. Kwiatkowski, H. Lee, H. C. Li, R. Mcelroy, M. Paleczny, D. Peek, P. Saab, D. Stafford, T. Tung, and V. Venkataramani, “Scaling Memcache at Facebook”, in NSDI 2013, and Twitter, see S. Ghandeharizadeh and J. Yap. “Cache Augmented Database Management Systems”. ACM SIGMOD 2013 Workshop—DBSocial, June 2013.

One challenge of CASQL systems is maintaining cached key-value pairs consistent in the presence of updates to their tabular representation in the RDBMS.

### SUMMARY

An SQL query-to-procedure translation system may be used in connection with a relational database management system (RDBMS) that is augmented by a cache and a cache management system that manages the cache. The query-to-procedure translation system may include a data processing system that has at least one computer hardware processor and a configuration that, in response to a query issued by an application program for data from the relational database management system: intercepts the query; generates code that determines if data requested by the query that may be in the cache has changed; and registers the code as a procedure with the RDBMS.

The data processing system may examine the query to determine whether it is of a form that is the same as a form of a previous query that resulted in the generation and registration of a trigger and, if so, may not generate or register an additional trigger.

In response to the query, the data processing system may generate code that determines if data requested by the query that is in the cache has changed since it was placed in the cache and may register the code as a trigger with the RDBMS.

The query may include a join predicate, a selection predicate, a range selection predicates, multiple predicates, and/or an aggregate function.

The procedure may be a trigger.

The data processing system may save the procedure and, in response to an RDBMS DML, execute the procedure.

A non-transitory, tangible, computer-readable storage medium may contain a program of instructions that may cause a computer system running the program of instructions to perform any one or more or all of the functions described above.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIGS. 1A-1B illustrate examples of alternative CASQL architectures.

FIG. 2 illustrates an example of a friendship graph used to author HumanTrig.

FIG. 3 illustrates a comparison between an example of SQLTrig and an example of HumaTrigger, where ω=100,000, φ=20, n=10,000, and ε=θ=0, with the RAYS benchmark.

FIG. 4 illustrates examples of throughput with four different workloads, M=10,000, T=100, with the BG benchmark.

FIG. 5 illustrates an example of the average response time of SemiData, QR and SQL-X as a percentage of write actions increases with the RAYS benchmark.

FIG. 6 illustrates an example of QR with refresh and invalidation, T=100, with the BG benchmark.

FIG. 7 illustrates an example comparison of COSAR-SQLTrig with memcached, M=10,000, T=100, with the BG benchmark.

FIG. 8 illustrates an example of a system that includes an application server containing an application and an SQLTrig client, a relational database management system (RDBMS), and a cache server.

FIG. 9 illustrates an example of a system that includes an SQLTrig module and a cache located locally within the application server.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

Middle-tier caches can enhance the performance of applications that exhibit a high read to write ratio and employ a relational database management system (RDBMS). The cache may be a key value store (KVS) that stores and retrieves key-value pairs computed using the normalized tabular data. An example KVS is memcached in use by some large well known sites, such as Facebook.

A challenge of Cache Augmented SQL RDBMSs (CASQL) is how to maintain the cached key-value pairs consistent with the database in the presence of updates to the RDBMS.

An SQLTrig framework is now described that addresses this challenge by translating SQL queries to triggers on the fly. Updates to the RDBMS may invoke the triggers to either invalidate or refresh the impacted key-value pairs. SQLTrig may support key-value pairs that correspond to either an SQL query and its result set (QR) or an application specified key whose value is computed using arbitrarily complex application logic that issues SQL queries to the RDBMS (SemiData). SQLTrig authored triggers may not be slower than human authored triggers. To the contrary, an analysis of a social networking web site reveals they are several times faster.

To address this challenge, a transparent cache consistency technique named SQL query-to-trigger translation, SQLTrig is now described. This run-time technique may intercept SQL queries issued by an application for a key-value pair, translate them into triggers, and may register the resulting triggers with the RDBMS. These triggers may notify the KVS of a change in the result of a query instance synchronously. In response, the KVS may either invalidate, see J. Challenger, P. Dantzig, and A. Iyengar, “A Scalable and Highly Available System for Serving Dynamic Data at Frequently Accessed Web Sites”, In ACM/IEEE SC, November 1998; A. Labrinidis and N. Roussopoulos, “Exploring the Tradeoff Between Performance and Data Freshness in Database-Driven Web Servers”, The VLDB Journal, 2004, or refresh, see J. Challenger, P. Dantzig, and A. Iyengar, “A Scalable System for Consistently Caching Dynamic Web Data”, In IEEE Computer and Communications Societies, 1999, the cached key-value pairs.

The number of triggers generated by an application may be finite and dictated by its number of distinct query templates that constitute the application. SQLTrig may generate three triggers per table: One for a row insert, a second for a row delete, and a third for a row update. SQLTrig may support queries with simple aggregates, selection (both range and exact-match) predicates, equijoin predicates, and their conjunctive and disjunctive combinations. These queries may retrieve a small amount of data from the underlying database.

One may deploy SQLTrig in two possible modes named Query Result (QR) and Semi structured Data (SemiData) caching. With QR, the KVS may be transparent to the programmer and the key-value pairs may be at the granularity of a query string and its result set. With SemiData, the application developer may identify execution of a code segment with a key whose result is a value stored in the KVS. SQLTrig may maintain the cached key-value pairs up to date in the presence of changes to the RDBMS with no additional software from the developer.

SQLTrig may provide physical data independence: The developer may be freed from the global reasoning on what RDBMS changes impact which key-value pairs and how updates to the RDBMS should propagate to the KVS. This may reduce the complexity of application software and expedite software development life cycle, empowering application developers to introduce features more rapidly at reduced costs. When configured to invalidate (instead of refresh) key-value pairs, SQLTrig may provide consistent reads and serial schedules. In experiments, SQLTrig generated triggers were more than three times faster than human provided triggers when utilizing the structure of queries and normalized data, instead of the semantics of the application.

SQLTrig may work with RDBMSs that support the concept of triggers. This may be realized used Internal Tokens (ITs) and requiring the KVS to maintain the mapping between an IT and the application specified key-value pair(s). SQLTrig may author triggers to produce ITs. The KVS may use the IT to identify the impacted key-value pairs to either delete or re-compute them. Different prototypes of SQLTrig may be made based on memcached and COSAR. See S. Ghandeharizadeh, J. Yap, and S. Barahmand, “COSAR-CQN: An Application Transparent Approach to Cache Consistency”, In International Conference On Software Engineering and Data Engineering, 2012, and the following RDBMSs: 64 bit MySQL 5.5.17, 32 bit PostgreSQL 9.0.6-1, 64 bit Oracle 11g Release 2.

SQLTrig generated triggers may result in a deployment that is faster than triggers provided by a human.

There may be tradeoffs associated with various settings of SQLTrig (QR and SemiData) using a social networking benchmark. SQL Query to Trigger Translation

SQLTrig may support two modes of caching that produce different key-value pairs:
Query result (QR) caching: The key, kᵢ is a query string and the value, vᵢ is its result set. The KVS may be transparent to the application developer. With RDBMS updates, SQLTrig may either invalidate or refresh the impacted key-value pairs.
Semi structured data (SemiData) caching: The key, k₁, may be specified by the developer and the value, vᵢ, may be computed by either a read-only function, see, D. R. K. Ports, A. T. Clements, I. Zhang, S. Madden, and B. Liskov, “Transactional consistency and automatic management in an application data cache”, In OSDI. USENIX, October 2010, or a code segment (CS_{fuse}). CS_{fuse} may consist of application specific logic that issues an arbitrary number of SQL queries and fuses their results together. It may consume some input, say user-id, to produce an output, HTML fragment (also termed webview) corresponding to the profile page of the user with the specified user-id. CS_{fuse} may start with a KVS look up for kᵢ. If vᵢ is not found then CS_{fuse} may execute to compute vᵢ and kᵢ−vᵢ may be stored in the KVS. If vᵢ is found, then it may be returned without executing CS_{fuse}. Updates that modify the results of one or more of the queries may be used to compute vᵢ to invoke triggers authored by SQLTrig to invalidate the cached kᵢ−vᵢ.

With both, the result of SQL queries may be the basis of key-value pairs. SQLTrig may use these queries to author triggers and construct internal tokens, ITs. The ITs may enable the KVS to identify application specified key-value pairs. To describe the trigger generation, the following terminology for an SQL query may be assumed:
SELECT target list
FROM tuple variable list
WHERE qualification list
   Moreover, a query template may be differentiated from its instances. A query template may correspond to an SQL statement with selection predicates referencing wild cards, e.g., name=* where * is an arbitrary value. A query instance may be a template whose wild cards are replaced with values, e.g., name=‘Shahram’. An application may consist of a finite number of query templates and may issue a very large number (e.g., billions) of instances of each template. Query instances may be the basis of key-value pairs in the KVS and may be identified using an IT.

When storing a key-value pair in the KVS, SQLTrig may construct one or more ITs using the query instance(s) that are the basis of this key-value pair and may maintain a mapping from the IT to the key-value pair. SQLTrig authored triggers may notify KVS of RDBMS updates that change the result of a query instance. They may compute one or more ITs that identify impacted key-value pairs.

With both QR and SemiData, SQLTrig may author the same set of triggers for a query template and all its instances. The concept of IT and its mapping to application specified key-value pairs may be required with SemiData because a code segment may execute multiple queries to compute a (developer specified) key-value pair. However, with QR, the trigger may generate impacted query strings (keys) directly. (Both the concept of IT and the mapping table may be redundant with QR.) To simplify the discussion and without loss of generality, the rest of section assumes that QR generates ITs the same way as SemiData and maintains mapping from an IT to a key.

The translation process is discussed in three steps. First, there may be a process for selection predicates. Next, this discussion may be extended to incorporate join predicates. Finally, aggregates are described. SQLTrig may not support nested queries or aggregate functions with a “having” clause and complex queries that resemble OLAP workloads.

### Selection Predicates

Translation of exact-match and range selection predicates in turn are described. Th is may assume conjunctive qualification lists. The processing of disjuncts is described subsequently.

Consider the following query with a qualification list consisting of exact-match selection predicates:
SELECT attr₁, attr₂, . . . , attrₙ
FROM R
WHERE attrₙ₊₁=C₁ AND attrₙ₊₂=C₂ AND . . .
   . . . AND attrₘ=Cₖ
      SQLTrig may construct the IT of this query using a deterministic function ƒ that identifies the k unique attributes referenced by the qualification list of the query, k=m−n. It may sort these k selection predicates alphabetically using their referenced attribute name, i.e., attrₙ₊₁, . . . , attrₘ. Next, it may extract their k constants, i.e., C₁, . . . , Cₖ. It may concatenate these constants together to construct (in addition, function ƒ may use the n attributes referenced by the target list of the query to differentiate between different queries that reference R with the same qualification list, constructing different ITs for these queries. To simplify discussion, this detail is not presented) the IT of this query instance.

Subsequently, SQLTrig may author a trigger to process each record r that is either inserted or deleted from relation R as follows. The trigger may extract the k attribute values of r that constitute the qualification list of the query, r.attrₙ₊₁, . . . , r.attrₘ. It may employ function ƒ to rearrange these attribute values to construct the IT of the corresponding key-value pair. An update may be processed as a delete of the old record and insert of a new record, computing two ITs. Each IT may identify one or more keys that may or may not be KVS resident.

Triggers may be authored to accumulate their ITs in an array. A final step of the trigger may invoke a user defined function (the delete library of the KVS) to delete ITs. The KVS may process the list by looking up each IT in a hash table to identify the impacted application key(s) to either invalidate or refresh them.

### Range Predicates

SQLTrig may construct one R-Tree for each query template whose qualification list references a range selection predicate. A dimension of the R-Tree may correspond to an attribute referenced by the conjunctive qualification list, see below for disjunctive predicates. A query instance may be a k dimensional polygon in the R-Tree (corresponding to its query template) and whose results are used to compute a key-value pair.

SQLTrig authored triggers may generate a k dimensional value, an IT, that probes the R-Tree for matching polygons. Each matching polygon may identify key-value pairs that may reside in the KVS and should be invalidated. SQLTrig may only supports value driven queries, where an attribute in a range selection predicate is compared with a constant, i.e., it may not support range predicates such as R. sal<R. age×100. Details are explained below.

Consider the following query instance with a range predicate referencing k different attributes of Table R:
SELECT attr₁, attr₂, . . . , attrₙ
FROM R
WHERE (attrₙ₊₁>C₁ AND attrₙ₊₁<C₂) AND . . .
   . . . AND (attrₘ>C₂ₖ and attrₘ<C₂ₖ₊₁)
      The qualification list may consist of k range predicates referencing k different attributes of R, k=m−n. This may be one unique combination of references for the k attributes, attrₙ₊₁ to attrₘ and SQLTrig may construct and maintain a k-dimensional R-Tree for this combination with each dimension corresponding to a unique attribute, attrₙ₊₁ to attrₘ. The k ranges {(C₁, C₂, . . . , (C₂ₖ, C₂ₖ₊₁)} specified by the query may constitute a k dimensional polygon that is inserted in the R-Tree to identify those keys whose values are computed using this query instance.

SQLTrig may author triggers by changing each range predicate to an exact match predicate and may employ the discussions herein with one difference: The trigger may tag its produced IT with a literal (say “Range”) that designates it for a range predicate, table name (R), and the referenced column names attrₙ₊ᵢ, . . . , attrₘ. Hence, an update, say an insert of tuple T, may cause the trigger to delete the k dimensional value {T.attrₙ₊₁, . . . , T.attrₘ}, concatenated with the aforementioned tokens. SQLTrig may parse this IT to detect that it pertains to a range query. The provided table and column names may identify a unique R-Tree. The KVS may use the k dimensional value (a point) to look up this R-Tree for the polygons containing the point. Each such polygon may identify one or more key-value pairs that are either deleted or refreshed by SQLTrig.

SQLTrig may support query templates with alternative arithmetic comparison operators ≦, ≧, <, and > by constructing R-Trees that maintain either open or closed intervals for a dimension. With this example query and others similar to it, the authored triggers may not differentiate between the different arithmetic comparison operators, producing a k dimensional point always. It may consist of the values of attributes attrₙ₊ᵢ, . . . , attrₘ of a tuple T of Table R that is either being inserted, deleted, or updated.

### Disjunctive Predicates

When the qualification list of a query consists of disjunctive predicates (‘or’ clauses), SQLTrig may apply Boolean logic to the qualification list of the query to construct several queries, each with a unique set of conjunctive predicates. The union of the results of these queries may compute the same result as the original query. Subsequently, SQLTrig may employ the discussions of the previous sections to translate each query into a set of triggers and ITs. As an example, consider the following query:
SELECT userid
FROM friends
WHERE status=‘2’AND (userid=‘869’ OR friendid=‘869’)

Using Boolean logic, SQLTrig may transform this query into two different queries: One with the qualification list “status=‘2’ AND userid=‘869’ and the other with “status=‘2’ AND friendid=‘869’”. SQLTrig may process each query per discussions above to author a set of triggers and construct ITs. The resulting ITs may be associated with the application keys whose values are computed using the original query with a disjunctive predicate.

The trigger for updates may construct two ITs: one for the old and a second for the new row. It may employ the attributes referenced by the query to detect a scenario when a tuple is replaced with itself. In this case, no key-value pair may be impacted and the authored trigger may not generate any ITs.

A similar approach may be employed with range selection predicates. As an example, consider the following query:
SELECT A1
FROM R
WHERE R. A2>C1 or R. A3<C2
   SQLTrig may represent this query as two queries. One with the qualification list “R.A2>C1” and a second with the qualification list “R.A3<C2”. SQLTrig may construct and maintain a one dimensional R-Tree for each, populating one with (C₁, ∞) and the other with (−∞, C₁). Both may map to one key-value pair computed using the original query.

Insertion of tuple T in R may invoke the SQLTrig authored trigger to construct two different points: One using value of T.A2 and a second using value of T.A3. Each may be concatenated with the identifier “Range”, table name R, and its respective column name (either A2 or A3). This may enable the server to identify the respective R-Tree to look up the impacted ranges. Each such range may identify zero or more key-value pairs that are either invalidated or deleted.

### Equijoin Predicates

SQLTrig may support SQL queries with qualification lists consisting of an arbitrary number of equijoin and selection predicates. As detailed above and below, its target may not be OLAP type of join queries with a high cardinality. Instead, it may target qualification lists that retrieve a small amount of the entire data set. An example query might be one that retrieves friends of a member of a social networking web site. This query might be as follows:
SELECT attr₁, attr₂, . . . , attrₙ
FROM R, S
WHERE R.attrₙ₊₁=S.attrᵢ and S.attrⱼ=Cᵢ
   where tables R and S might be Friendship and Members tables and C1 is the id of a member. Such queries may be termed as RJoinExactMatchS. Now explained is how SQLTrig translates this specific query. Subsequently, the discussion is extended to more complex qualification lists with an arbitrary number of join and selection (both range and exact-match) predicates.

With RJoinExactMatchS, SQLTrig may construct IT of the query instance by concatenating the join predicate, R.attrₙ₊₁=S.attrᵢ, with the constant C1. For the query template, SQLTrig may author two sets of triggers, one for Table R and a second for Table S. Both sets compute the same IT. However, the body of triggers for R may be different than those for S. When a record s is inserted into (or deleted from) S, the SQLTrig authored trigger on S may concatenate s.attrᵢ with the hard coded string token “R.attrₙ₊₁=S.attrᵢ” and delete the resulting IT. On the other hand, when a record r is inserted in (deleted from) R, the authored trigger on R may employ r.attrₙ₊₁ to identify those records s with matching attrᵢ value: {s₁, s₂, . . . , sₙ}. For each s₁, the trigger may concatenate s₁.attrᵢ with the hard coded string token “R.attrₙ₊₁=S.attrᵢ” and delete the resulting ITs. Updates of a row of each table R and S may be the delete of the old row and insertion of the new row for each table, respectively. While the update trigger on R may produce an IT each time the value of attrₙ₊₁ is updated, the update trigger on S may be authored with sufficient logic to produce an IT when either S.attrᵢ or S.attrᵢ is updated.

With a qualification list consisting of conjuncts of multiple exact match selection predicates referencing a single table S, SQLTrig may author the trigger body of Table S to employ the attributes referenced by each selection predicate when processing rows inserted in (deleted from) S. With Table R, SQLTrig may author the trigger body to use the value of the referenced attributes from records {s₁, s₂, . . . , sₙ} that join the old/new record (r.attrₙ₊₁=s₁.attrᵢ).

When the qualification list consists of a mix of exact match selection predicates referencing different tables in combination with a join, an insert in (delete from) each table may look up the attribute value of the matching records in the other table that participated in the selection predicate. This may be done for all selection predicates.

When a join query involves a range selection predicates, SQLTrig may process the query as before with the following difference: The trigger may be authored to generate ITs with the “Range” token from the discussion in Section 2.1.1, as well as the table name and participating column names followed by their values. When this IT is provided to the KVS, it may be interpreted as a range query and the string token, “R.attrₙ₊₁=S.attrᵢ”, may be used in addition to the table and column names to identify a unique R-Tree (corresponding to a unique query template). Different values of C1 may result in different instances indexed by the R-Tree.

A query with a different join predicate but the same range selection predicate S.attrᵢ<C1 may be a new query template and assigned a new R-Tree. An alternative design would be to store each join predicate string as a separate dimension on the R-Tree. It is debatable if such query templates are common enough for this alternative design to yield much benefit.

### Simple Aggregates

Aggregates such as count can be a common query with social networking applications. An example query is one that counts the number of friends for a given user:
SELECT count(f.friendid)
FROM friends f
WHERE f.userid=‘869’
   SQLTrig may author triggers and constructs ITs for such queries by rewriting their target list to eliminate the aggregate. Subsequently, it may use the discussions of the previous 3 sections to author triggers and generate ITs. With the example query, “count(f.friendid)” is replaced with “f.friendid”. With “count(*)”, the “*” is replaced with the primary key of the referenced table.

With aggregates that have no qualification lists, e.g., the sum of all values in a column, SQLTrig may associates KVS key-value pairs with the name of the reference table and the columns of interest. It may author triggers to generate the table name concatenated with the referenced columns as the IT. This may invalidate key-value pairs with any change involving those column values on record inserts, deletes and updates. The count aggregate with no qualification list may be a special case where the key-value pair is associated with the table name and is invalidated at the granularity of a table change. However, only inserts and deletes may generate ITs as updates may not affect the number of rows.

### Consistency

SQLTrig may support consistent reads and produce a serial schedule of executed transactions due to three invariants presented in this section. These may differentiate between read/write operations of the RDBMS and the KVS. With the RDBMS, these operations may pertain to transactions. With the KVS, these operations may include the following simple operations: get, put, and delete. A KVS get may be equivalent to execution of one read transaction with QR and one or more read transactions with SemiData. A serial schedule may be at the granularity of transactions.

The invariants may be realized based on an implementation of SQLTrig that satisfies the following five properties:

1. RDBMS implements ACID transaction properties, preventing dirty reads, dirty writes, and un-repeatable reads.

2. Prior to populating the KVS with a key-value pair, SQLTrig registers triggers associated with the key-value pair and establishes the mapping between ITs and the key.

3. SQLTrig does not cache the result of queries that are a part of a multi-statement transaction.

4. RDBMS synchronously executes (SQLTrig authored) triggers as a part of a transaction that updates the database. During execution of the trigger, readers of the affected rows may be blocked and have to wait for the completion of the write transaction invoking the trigger (see below for a discussion of multi-version concurrency scheme, see P. Bernstein and N. Goodman, “Multiversion Concurrency Control—Theory and Algorihthms”, ACM Transactions on Database Systems, 8:465-483, February 1983, that allows readers to not block for a writer). Once a trigger invokes the KVS server to delete an IT, the KVS server may delete the corresponding key and return success. If this fails, then the trigger may fail and the transaction may abort. In order for a transaction to commit, all its invoked triggers may need to execute successfully. This may apply to the invalidation technique discussed below. (Refresh technique produces stale reads, see below.)

5. SQLTrig employs the gumball technique, see S. Ghandeharizadeh and J. Yap, “Gumball: A Race Condition Prevention Technique for Cache Augmented SQL Database Management Systems”, In ACM SIGMOD Workshop on Databases and Social Networks (DBSocial), 2012, GT, to detect and resolve write-write conflicts that occur due to the coupling of RDBMS and KVS that impact the correctness of a subsequent read transaction that observes a KVS hit. When the application observes a KVS miss for a query, it may execute a read transaction against the RDBMS and store its resulting key-value pair in the KVS with a put operation. This read transaction may race with a write transaction that invokes a trigger to delete the same key-value pair. The trigger delete may occur prior to the read transaction inserting its stale key-value pair in the KVS, causing the KVS to contain stale key-value pairs. GT may enable the KVS to detect this race condition and ignore the put operation. This may ensure the application will observe either a key-value pair that is consistent with the tabular data or a KVS miss that redirects it to issue a transaction to the RDBMS.

Invariant 1: All key-value pairs produced by the KVS at time T₁ are consistent with the state of the tabular database at time T₁, reflecting all committed transactions up to T₁.

Three properties may guarantee the correctness of this invariant. First, Property 2 may ensure a transaction that updates the RDBMS invalidates the corresponding key-value pair. Second, Property 4 may ensure a transaction does not commit until the invalidation is complete. If the body of the trigger fails, then the RDBMS may abort the transaction, leaving the state of the database consistent with the key-value pairs. This may guarantee that a thread observes its own updates to the database because, once it issues a transaction, it may not be able to proceed until its RDBMS update is reflected in the KVS. Thus, for all committed transactions, triggers may have invalidated all impacted key-value pairs. One or more of these invalidated key-value pairs may become cache resident soon after an invalidation because a subsequent reference for them observes a KVS miss, issues transactions to the RDBMS, computes these key-value pairs, and inserts their most up-to-date version in the KVS. These entries may be consistent with the state of the database and reflect all committed transactions due to Property 1 which serializes RDBMS read and write transactions.

Third, Property 5 may detect and resolve KVS put-delete (i.e., write-write) race conditions that cause the key-value pairs to become inconsistent with the tabular database.

Invariant 2: No key-value pair in the cache reflects uncommitted RDBMS transactions (both mid-flight and aborted transactions).

Property 1 may prevent data from a mid-flight RDBMS write transaction to be visible to other concurrently executing transactions. This prevents both dirty reads and unrepeatable reads, guaranteeing computed key-value pairs reflect result of queries computed using a consistent database state.

A mid-flight DML transaction may abort and result in one of two possible scenarios. First, the transaction aborts before causing the trigger to fire and invalidate the KVS. In this case, the contents of the KVS and the state of data in the RDBMS may be unchanged and consistent with one another. Second, the transaction aborts after the trigger fires and executes its invalidation code, purging key-value pair. In this case, the invalidation may be redundant because the state of the database is unchanged (aborted transaction is rolled back). While this may degrade system performance, it may not violate the consistency of the framework because KVS contains key-value pairs corresponding to a subset of tabular data. Moreover, a subsequent reference for the purged key-value pair may observe a KVS miss and rec-ompute the same key-value pair using the tabular data.

Invariant 3: Read-write conflicts due to concurrent transactions manipulating the same data item are serializable.

Consider two transactions that access the same data item D₁. One transaction reads D₁ while the second updates D₁. Their concurrent execution may result in two possible scenarios. In the first scenario, the reader may observe a cache miss (because the writer deleted D₁ an from the KVS) and may be redirected to the RDBMS which may guarantee the serial schedule between the reader and the writer. In the second scenario, the reader may consume D₁ from the KVS and the writer may delete it subsequently. In this case, the reader may be ordered to occur prior to the updating transaction to produce a serial schedule.

These three invariants may guarantee that the SQLTrig produces serial schedule of transactions. Below validates the claims of this section experimentally using a social networking benchmark that measures the amount of stale data produced by a data store.

### Multiversion Concurrency Control

Multiversion Concurrency Control (MVCC) may enable simultaneous transactions to access the database concurrently using different versions of the data. When a transaction modifies a piece of data, the RDBMS may maintain its previous versions to serialize read requests without blocking them. That view of the data may be consistent at a point in time under Snapshot Isolation, which may not guarantee serialization in all cases, but may be adequate for applications like the TPC-C benchmark, see A. Fekete, D. Liarokapis, E. J. O′Neil, P. E. O′Neil, and D. Shasha, “Making snapshot isolation serializable”, ACM Transactions on Database Systems, 30(2):492-528, 2005.

When inserting a key-value pair in the KVS, it may be important that the value reflects the most recent state of the data. With a non-MVCC RDBMS, a writer W₁, that invokes the invalidation may commit before a reader, R₁, observes W₁'s produced value. However, with MVCC, R₁, no longer waits for W₁ to commit with the latest value. Instead, R₁ may read a stale value and store a stale key-value pair into the KVS (assuming W₁ commits). This may cause the KVS to become inconsistent with the RDBMS and a subsequent KVS read observes stale data. (GT, see Property 5, does not prevent such race conditions.)

One may avoid the produced stale data by forcing read transactions to wait for write transactions to complete. This can be done in several ways. First, some RDBMS support the feature to turn MVCC off. Alternatively, to ensure Property 4, one may require a transaction to acquire a Shared lock on the table being queried and an eXclusive lock when inserting, deleting, or updating a table. This might be performed either in the application layer or within the client interface wrapper of the RDBMS, see Section 4.1. In experiments, locking imposed at most 6% overhead while eliminating all stale reads due to MVCC.

### An Implementation

SQLTrig may implement QR and SemiData (see Section 2) by exposing different functionalities. To illustrate, consider an application written in Java using JDBC client of a RDBMS. When in QR mode, SQLTrig may expose the standard JDBC interface to the software developer, hiding the cache all together. When in SemiData mode, SQLTrig may expose both the JDBC interface and the simple put, get, delete operations of the cache server.

Given the execution of an application, SQLTrig client may produce the same set of triggers and ITs for both QR and SemiData. QR and SemiData may be different in two ways. First, SemiData may issue fewer put calls to the cache server because each inserted key-value pair correspond to a code segment CS_{fuse} that may execute multiple queries. QR may represent each executed query in CS_{fuse} as a key and its result set as a value issuing the same number of put calls as the number of executed queries. Second, the mapping cardinality between IT and a key may be smaller with QR. With QR, each unique query may produce several ITs that are associated with one key, the query string. With SemiData, CS_{fuse} may execute several unique queries that produce a collection of ITs that are mapped to one key, the developer specified key.

FIGS. 1A-1B illustrate examples of alternative CASQL architectures. One may incorporate SQLTrig into a variety of CASQL architectures, as shown in FIG. 1. With the Shared Address Space, SAS, the KVS may be a library that implements SQLTrig to act as an intermediary between the application and the RDBMS, see A. Iyengar and J. Challenger, “Improving Web Server Performance by Caching Dynamic Data”, In In Proceedings of the USENIX Symposium on Internet Technologies and Systems, pages 49-60, 1997; J. Challenger, P. Dantzig, and A. Iyengar, “A Scalable System for Consistently Caching Dynamic Web Data”, In IEEE Computer and Communications Societies, 1999; L. Degenaro, A. Iyengar, I. Lipkind, and I. Rouvellou, “A Middleware System Which Intelligently Caches Query Results”, In IFIP/ACM International Conference on Distributed systems platforms, 2000; K. Yagoub, D. Florescu, V. Issarny, and P. Valduriez, “Caching Strategies for Data-Intensive Web Sites”, In VLDB, pages 188-199, 2000. It may provide the optimum read service time by staging content in the same process as the application, eliminating the overhead of inter-process and inter-processor communication. It may also exhibit a sub-optimal scalability characteristic for updates by duplicating popular key-value pairs in each Client cache instance, requiring each invalidation (refresh) to be propagated to all cache instances. Examples of the SAS architecture include Terracotta Ehcache, see Terracotta. Ehcache, S. Ghandeharizadeh and J. Yap. “Cache Augmented Database Management Systems”. ACM SIGMOD 2013 Workshop—DBSocial, June 2013, and JBoss Cache, see JBoss Cache. JBoss Cache, S. Ghandeharizadeh and J. Yap. “Cache Augmented Database Management Systems”. ACM SIGMOD 2013 Workshop—DBSocial, June 2013. None may include a transparent caching technique, such as SQLTrig, and require developer provided software to maintain key-value pairs consistent with the state of the database.

With a client-server architecture, CS, the cache manager, may consist of a client and a server component that communicate via message passing, see C. Amza, A. L. Cox, and W. Zwaenepoel, “A Comparative Evaluation of Transparent Scaling Techniques for Dynamic Content Servers”, In ICDE, 2005; C. Amza, G. Soundararajan, and E. Cecchet, “Transparent Caching with Strong Consistency in Dynamic Content Web Sites”, In Supercomputing, ICS '05, pages 264-273, New York, N.Y., USA, 2005. ACM; A. Datta, K. Dutta, H. Thomas, D. VanderMeer, D. VanderMeer, K. Ramamritham, and D. Fishman, “A Comparative Study of Alternative Middle Tier Caching Solutions to Support DynamicWeb Content Acceleration” In VLDB, pages 667-670, 2001. Both components may participate in implementing SQLTrig, see below. Example systems include memcached, see memcached. Memcached, S. Ghandeharizadeh and J. Yap. “Cache Augmented Database Management Systems”. ACM SIGMOD 2013 Workshop—DBSocial, June 2013, and COSAR, see S. Ghandeharizadeh, J. Yap, and S. Barahmand, “COSAR-CQN: An Application Transparent Approach to Cache Consistency”, In International Conference On Software Engineering and Data Engineering, 2012. Typically, key-value pairs may be partitioned across the KVS server instances. Hence, a key-value invalidation may impact one server instance. The service time of reads with this architecture may be worse than SAS because the client component incurs the overhead of communicating with the server that might be running on a different node, see S. Ghandeharizadeh and J. Yap. “Cache Augmented Database Management Systems”. ACM SIGMOD 2013 Workshop—DBSocial, June 2013.

A discussion of the two architectures and their tradeoffs may consider issues such as scalability, elasticity, and data availability in the presence of RDBMS and KVS failures. (See, S. Ghandeharizadeh and J. Yap. “Cache Augmented Database Management Systems”. ACM SIGMOD 2013 Workshop—DBSocial, June 2013; S. Barahmand, S. Ghandeharizadeh, and J. Yap. “A Comparison of Two Physical Data Designs for Interactive Social Networking Actions”. CIKM, 2013, for a quantitative comparison of the two architectures.) Instead, SQLTrig is presented assuming a simple CS architecture consisting of one RDBMS and one COSAR server instance that implements SQLTrig. Similar to memcached, COSAR consists of a client and a server component, see FIG. 1B. The client component, named SQLTrig client, may intercept the SQL queries issued by the application, generates ITs (ITs}) and trigger bodies ({Trigs}). Next, it may issue an SQLT-PUT(kᵢ, vᵢ,{Trigs}, {ITs}) to the SQLTrig server. This is a COSAR server extended to register (r triggers) with the RDBMS. Moreover, it may implement properties 2 and 5 above. RDBMS inserts, deletes and updates invoke triggers to delete (refresh) ITs. SQLTrig server processes these calls by identifying the impacted key-value pairs and deleting (refreshing) them.

Below, SQLTrig client and server components are in turn described. SQLTrig Client

SQLTrig client may be a software component that enables an application to communicate with the SQLTrig server. It may substitute for the memcached client shown in FIG. 1B. Its implementation may be different with QR and SemiData. Below, each is described in turn.

With QR, the SQLTrig client may be a wrapper that either overrides or extends the API to access a RDBMS. With Java, it may override the JDBC API to utilize KVS operations as follows. A single statement query may be treated as a key-value look up using the query string as the key kᵢ. If the KVS returns a value vᵢ then the client may deserialize vᵢ as the query result set and provides it to the application. Otherwise, it may employ the original JDBC driver to issue the query to the RDBMS and obtain the result set which it serializes to obtain the value vᵢ, see below for details of marshalling query result sets. Next, it may translate the query into a set of triggers and ITs, see below. This information may be provided as a part of the key-value insertion to the SQLTrig server, SQLT-PUT (kᵢ,vᵢ,{Trigs}, {ITs}).

With SemiData, the SQLTrig client may provide the developer with both the JDBC interface to issue queries to the RDBMS and KVS put, get, and delete operations. It may detect when the application looks up key kᵢ and observe a cache miss. In the background, it may memoize the queries issued by the application to the point when a put is issued for kᵢ−vᵢ. Once the application issues put(kᵢ−vᵢ), SQLTrig may translate the set of queries used to compute kᵢ−vᵢ into a collection of triggers and ITs. This information may be provided as a part of the put operation to the SQLTrig server, SQLT-PUT(kᵢ, vᵢ,{Trigs}, {ITs}).

### SQLTrig Server

The SQLTrig server may be a wrapper for the COSAR KVS and may extend its put and delete operations to realize the SQLTrig framework. It may be neutral to both QR and SemiData by simply implementing SQLT-PUT(kᵢ, vᵢ,{Trigs}, {ITs}). Triggers may pertain to query templates and may be identical for the many instances of one template. Internal tokens in set {ITs} may be unique to each query instance.

SQLTrig server may maintain a hash table (This table may consist of a few thousand entries, where each entry is in the order of hundreds of bytes) of the triggers that have been registered with the RDBMS successfully. If each trigger in the set {Trigs} is found in the hash table of the registered triggers, SQLTrig may perform the following two steps in turn. First, for each ITᵢ in the set {IT}, it may register ITᵢ−kᵢ with the KVS. Next, it may insert (Implements GT's, see S. Ghandeharizadeh and J. Yap, “Gumball: A Race Condition Prevention Technique for Cache Augmented SQL Database Management Systems”, In ACM SIGMOD Workshop on Databases and Social Networks (DBSocial), 2012, protocol.) kᵢ−vᵢ into the KVS. If a trigger in the set {Trigs} is not found in this hash table, SQLTrig may place the trigger in a registration queue and returns without inserting kᵢ−vᵢ in the KVS, i.e., discards kᵢ−vᵢ and the provided {ITs}. A background trigger registration thread may consume elements of the trigger queue and issues commands to register them with the RDBMS. Once a trigger is registered successfully, the registration thread may insert the trigger in the hash table of registered triggers and proceed to the next element of its queue.

With deletes, the SQLTrig server may differentiate between those issued by the SQLTrig client authored triggers and the application. It may do so by authoring triggers to call a specific delete operation supported by the SQLTrig server. Semantically, an application may delete keys while the authored triggers delete ITs which in turn delete keys. With application delete for k₁, the server may delete kᵢ. With trigger deletes for ITᵢ, the server may look up IT, to obtain its corresponding kᵢ and deletes kᵢ. kᵢ may or may not reside in the SQLTrig server.

### Refresh and Invalidation

With QR, the SQLTrig server may respond to RDBMS trigger delete calls for kᵢ−vᵢ (after kᵢ look up using ITᵢ) in two ways, either refresh or invalidate kᵢ−vᵢ. (SemiData may invalidate key-value pairs only, see below.) With refresh, the SQLTrig server may execute the query pertaining to kᵢ−vᵢ in the background to update vᵢ. It may do so because kᵢ is the query string pertaining to a query instance. While computing the new vᵢ, the server may produce stale values for those requests referencing kᵢ.

With invalidation, the SQLTrig server may delete kᵢ−vᵢ, causing the application's subsequent reference for kᵢ to observe a miss, issue a query to the RDBMS, and populate the server with the new kᵢ−vᵢ pair. If kᵢ−vᵢ is popular, multiple independent threads may observe a miss simultaneously and execute the same query using the RDBMS. SQLTrig may employ the gumball technique, see S. Ghandeharizadeh and J. Yap, “Gumball: A Race Condition Prevention Technique for Cache Augmented SQL Database Management Systems”, In ACM SIGMOD Workshop on Databases and Social Networks (DBSocial), 2012, to prevent write-write race conditions between the RDBMS triggers invalidating key-value pairs and SQLTrig clients populating the server, preventing key-value pairs that are inconsistent with the tabular database.

SemiData may implement the invalidation technique only. It may implement refresh if the developer pro-vides additional software to compute a value vᵢ for kᵢ. This may be contrary to SQLTrig's objective to realize a transparent cache server and is not discussed further herein.

### Query Result Caching, QR

QR may be implemented by wrapping the JDBC driver of a RDBMS into the SQLTrig client, hiding the distinction between the RDBMS and the SQLTrig server from the application developer. To respect the consistency guarantees implemented by the developer, QR may not materialize key-value pairs pertaining to queries issued as a part of a multi-statement transaction.

The technique used to serialize and deserialize (marshall) the result of SQL queries may impact QR significantly. Ideally, a marshalling technique may be fast, efficient and produce the most compact serialized representation. With the Java programming language, this may be done by marshalling a serializable version of the JDBC ResultSet class. Since the general ResultSet class may not be serializable, it may have to be converted into an object that does support serialization. One such method is to employ the CachedRowSet implementation (A commercial RDBMS software vendor may provide its own implementation of CachedRowSet as a part of its JDBC driver, e.g., OracleCachedRowSet. One may use this instead of the generic implementation) (by Sun, now Oracle) to generate a serializable instance of the query ResultSet class. This instance may be populated with a ResultSet obtained by executing a query. Next, this instance may be serialized into an array of bytes using the Java writeObject call. The resulting array of bytes may be stored as the value portion of a key-value pair in the KVS. QR may compress this array to minimize its memory footprint and network transmission time. When un-marshalling this array of bytes after reading it from the SQLTrig server, a corresponding Java read-Object call may be used to rebuild the original CachedRowSet instance. The Java marshalling and un-marshalling of objects can be expensive because they are designed to handle arbitrarily complex classes. To avoid this overhead, a different marshalling of the ResultSet may be implemented. It may outperform the Java marshalling technique because it may be aware of the specific structure of the ResultSet object. It may retrieve its number of columns and rows and store them as the first eight bytes of an array. Subsequently, it may store the meta-data information for a column (name, length, table name, type) and its values for every row, producing a column store representation. Today, with variable length columns such as varchar, its data may be stored as a series of {length, value} pair. An alternative representation may be to store all {length} values followed by {value} of the columns. This may most likely produce a more compact representation when compressing the serialized representation.

TABLE 1
Marshalling of YCSB Workload C ResultSet with SQLTrig and Java.

| | SQLTrig Marshalling | | Generic Java Marshalling | |
|---|---|---|---|---|
| | No | With | No | With |
| | Compression | Compression | Compression | Compression |
| Average Size | 1,536 | 972 | 7,671 | 3,787 |
| (bytes) | | | | |
| Average | 102 | 117 | 317 | 875 |
| Latency | | | | |
| (μs) | | | | |

The YCSB benchmark may be used, see B. F. Cooper, A. Silberstein, E. Tam, R. Ramakrishnan, and R. Sears, “Benchmarking Cloud Serving Systems with YCSB”, In Cloud Computing, 2010, (Workload C) to compare the generic Java marshalling technique with this implementation. YCSB may be configured with one table consisting of ten string columns. Each column may be 100 bytes long. The target query may retrieve all columns of a single row.

Table 1 illustrates marshalling of YCSB Workload C ResultSet with SQLTrig and Java. The first row of Table 1 shows the average size of the resulting object with both SQLTrig's marshalling technique and the generic Java marshalling technique. The SQLTrig's marshalling technique may result in representations that are 3 to 4 times smaller in both compressed and uncompressed format. Moreover, the service time to both generate and compares (Compression may enable a more scalable infrastructure because it may free shared resources such as the cache space and the network bandwidth) the value may be faster with SQLTrig's implementation, see the second row of Table 1.

In this experiment, the RDBMS, cache server, and the client are hosted on the same PC. While there are inter-process communications, there are no inter-processor communications.

### An Evaluation

This section uses the implementation of the section above to evaluate SQLTrig in two ways. First, in a case study to compare SQLTrig with human authored triggers for a social networking application named RAYS. Second, to compare QR and SemiData caching granularities. A Case Study

An experimental social networking site was used named RAYS, see S. Barahmand, S. Ghandeharizadeh, A. Ojha, and J. Yap. 2010. “Three highly available data streaming techniques and their tradeoffs”, in ACM workshop on Advanced video streaming techniques for peer-to-peer networks and social networking (AVSTP2P '10), 2010, to compare SQLTrig with a developer provided consistency solution. Key findings include: First, SQLTrig may require minimal software changes and may avoid the software development life cycle of an application specific consistency technique. Second, in experiments, SQLTrig authored triggers were several times faster than the developer provided triggers. This is because SQLTrig utilizes the structure of the queries to author triggers, while the developer utilizes semantics of the application. Below begins with a brief overview of the social networking site and the transitive dependency that impacts cached entries. Subsequently, SQLTrig is compared with developer provided software.

### Rays

RAYS envisions a social networking web site that empowers its users to register a profile, form a social network, register devices that produce live streams such as smartphones and inexpensive cameras from Pansonic and Linksys, initiate and stop streams from their devices, and share streams with their friends. The profile page of a user, say Bob, shows (1) how many of Bob's devices are actively streaming and (2) a picture of those friends of Bob with an active stream. A user Bob may browse the profile page of other users. When Bob visits the profile page of his friend Alice, RAYS shows Bob those friends of Alice with an active stream. This is somewhat similar to the Wall of Facebook, Bulletin board of MySpace, and Scrapbook of Orkut, see F. Benevenuto, T. Rodrigues, M. Cha, and V. A. F. Almeida, “Characterizing User Behavior In Online Social Networks”, In Internet Measurement Conference, 2009.

RAYS implements the profile page of its members using several HTML fragments. Using SemiData caching, RAYS stores these HTML fragments as key-value pairs and looks them up to enhance performance. Every time a user, say Alice, toggles the status of one of her streaming device from on to off and vice versa, an HTML fragment of her profile page (key=lnfo:Alice, value=HTML fragment) is invalidated as it shows Alice's number of streaming devices. Moreover, this action may invalidate an HTML fragment of the profile page of each of Alice's friends (key=LiveFriends:Bob) as it shows whether Bob's friend (i.e., Alice) has a streaming device. Without SQLTrig, the developer must provide software to maintain keys Info:Alice and LiveFriends:Bob up to date.

When Alice visits the profile page of her friend Bob, the resulting HTML page is customized (the customization is to enable Alice to send either a message or an invitation to Bob to view a live stream) for Alice and shows those friends of Bob with a streaming device, key=Frd:Alice:Bob. This key-value pair might be invalidated by a user who is a friend of Bob and not Alice. To illustrate, if Mary who is a friend of Bob toggles the status of her streaming device then the cached Frd:Alice:Bob is no longer up to date. SQLTrig invalidates these entries by authoring triggers that employ the structure of the queries (join predicates) used to compute transitive relationships between different rows of tables. A key ingredient is the ITs and their one-to-many and many-to-one relationship with the application keys.

Without SQLTrig, the application developer must provide additional software to maintain the cached key-value pairs consistent. In the following, we describe one such implementation.

### HumanTrig

It is challenging to author software to maintain values of keys such as as Frd:Alice:Bob consistent with tabular data due to their transitive dependencies. They require the developer to perform global reasoning about the different rows and how the application's update impacts the different key-value pairs.

To illustrate, FIG. 2 illustrates an example of a friend relationship between 6 users of RAYS: Alice is friends with Bob and John, John is friends with Kate and Alice, Bob is friends with Mary and Fred, Mary and Fred share Bob as their only friend, and Kate has John as her only friend. If Alice toggles the status of her device then the system must invalidate all those keys corresponding to Frd:Alice:Bob, Frd:Alice:John, Frd:Mary:Bob, Frd:Fred:Bob, and Frd:Kate:John. It is not necessary to delete keys such as Frd:Bob:Mary, Frd:John:Kate, or Frd:Bob:Fred because Alice's change of device status does not impact their value. To capture this transitivity, each member of RAYS is conceptualized as a node of a graph and friendship between two members, nodes mᵢ and mⱼ, as two different directed edges. One from node mᵢ to mⱼ and a second from node mⱼ to mᵢ. When mᵢ toggles the status of his or her device, the system should delete the cached entries corresponding to those nodes with an edge to either mᵢ or those that are a friend of mᵢ. More formally, when user mᵢ toggles the status of his or her device, the system computes all friends of mᵢ: ƒ₁, ƒ₂, . . . ƒₙ. For each node ƒₗ, those nodes who are friends of t₁, t₂, . . . , tₖ is computed. Values associated with keys Frd: mᵢ: Frd: ƒₗ: mᵢ, and Frd: tᵢ: ƒᵢ are deleted. It is not necessary to delete value of keys Frd: ƒₗ: tᵢ because they are not impacted. This implementation is named HumanTrig

FIG. 3 illustrates a comparison of SQLTrig with HumanTrigger, where ω=100,000, φ=20, n=10,000, ε=θ=0, with the RAYS benchmark.

Comparison of SQLTrig with HumanTrig

SQLTrig eliminates the rationalization of HumanTrig. It employs the SQL queries used to compute the key-value pairs to author triggers that maintain the KVS consistent. Less than 1 man hour was needed to substitute SQLTrig JDBC with the RDBMS JDBC driver used by RAYS. Design, development, testing and debugging of HumanTrig required approximately 80-90 man hours. This included the time spent finding logical errors such as deleting more keys than necessary.

Next, the time required for one thread to issue 1,000 SQL update commands that toggles the status of a streaming device was measured.

FIG. 3 illustrates a a comparison between an example of SQLTrig and an example of HumaTrigger, where ω=100,000, φ0=20, n=10,000, and ε=θ=0, with the RAYS benchmark. FIG. 3 shows the average response time of each update with HumanTrig and SQLTrig as a function of the number of simultaneous threads issuing the update. With 20 to 50 simultaneous threads, SQLTrig is 8 to 12 times faster than HumanTrig (4 msec versus 50 msec). This difference remains constant with different database sizes (1K, 10K and 100K users) and different number of friends per user (2, 10, 20, and 50 friends per user).

SQLTrig is faster than HumanTrig because its produced software is different than the one provided by HumanTrig. SQLTrig detects database changes that modify the results of a query used to compute a cached entry. This depends on the structure of the normalized tables and the join queries that manipulate them. HumanTrig ignores these important details and conceptualizes the validity of cached key-value pairs as a graph consisting of nodes with directed edges. While the latter results in software that is more logical and intuitive, it is not as efficient as the software produced by SQLTrig. It is possible for a human to analyze the SQLTrig authored triggers and rationalize their correctness (using the discussions of Section 2). However, this requires a time consuming analysis of internal keys, their mapping cordiality (one-to-one, many-to-one, one-to-many) with the application keys, and the SQL queries.

The obtained results suggest the use of query structures to author triggers does not mean a framework that is slower than human provided triggers. See below.

A Comparison of QR with SemiData

This section quantifies possible tradeoffs associated with QR and SemiData. Subsequently, it focuses on QR to quantify tradeoffs associated with invalidation and refresh modes of operation. This evaluation is conducted (consideration was given to using other popular benchmarking tools, such as RUBiS, see C. Amza, A. Chanda, A. Cox, S. Elnikety, R. Gil, K. Rajamani, W. Zwaenepoel, E. Cecchet, and J. Marguerite, “Specification and Implementation of Dynamic Web Site Benchmarks”, In Workshop on Workload Characterization, 2002, YCSB, see B. F. Cooper, A. Silberstein, E. Tam, R. Ramakrishnan, and R. Sears, “Benchmarking Cloud Serving Systems with YCSB”, In Cloud Computing, 2010, and YCSB++, see S. Patil, M. Polte, K. Ren, W. Tantisiriroj, L. Xiao, J. López, G. Gibson, A. Fuchs, and B. Rinaldi, “YCSB++: Benchmarking and Performance Debugging Advanced Features in Scalable Table Stores”, In Cloud Computing, New York, N.Y., USA, 2011, ACM. We could not use RUBiS and YCSB, see B. F. Cooper, A. Silberstein, E. Tam, R. Ramakrishnan, and R. Sears, “Benchmarking Cloud Serving Systems with YCSB”, In Cloud Computing, 2010, because neither quantifies the amount of stale data. The inconsistency window metric quantified by YCSB++, see S. Patil, M. Polte, K. Ren, W. Tantisiriroj, L. Xiao, J. López, G. Gibson, A. Fuchs, and B. Rinaldi, “YCSB++: Benchmarking and Performance Debugging Advanced Features in Scalable Table Stores”, In Cloud Computing, New York, N.Y., USA, 2011, ACM, measures the delay from when an update is issued until it is consistently reflected in the system. YCSB++, see S. Patil, M. Polte, K. Ren, W. Tantisiriroj, L. Xiao, J. López, G. Gibson, A. Fuchs, and B. Rinaldi, “YCSB++: Benchmarking and Performance Debugging Advanced Features in Scalable Table Stores”, In Cloud Computing, New York, N.Y., USA, 2011, ACM, measures the delay from when an update is issued until it is consistently reflected in the system) using both a social networking benchmark named BG, see S. Barahmand and S. Ghandeharizadeh, “BG: A Benchmark to Interactive Social Networking Actions”, CIDR, January 2013, and an implementation with RAYS, see S. Barahmand, S. Ghandeharizadeh, A. Ojha, and J. Yap. 2010. “Three highly available data streaming techniques and their tradeoffs”, in ACM workshop on Advanced video streaming techniques for peer-to-peer networks and social networking (AVSTP2P '10), 2010. Key findings include:
With both BG and RAYS, SemiData outperforms QR when either memory is scarce or CPU is completely utilized. This is because SemiData caches the final results of a code fragment, resulting in fewer key-value pairs that are smaller in size. Even with a 100% cache hit rate, QR incurs the overhead of gluing the result sets together to compute the final value that SemiData looks up in the cache. This CPU overhead slows down QR, enabling SemiData to outperform it by a factor of two in those experiments with a high read to write ratio.
With RAYS, QR outperforms SemiData when writes are more frequent. This is because a key-value pair cached by SemiData may correspond to tens of cached query results with QR. When SemiData invalidates one of its key-value pairs, it must execute all these queries. With QR, only a subset of these query results are invalidated, enabling QR to look up the results of the remaining queries. This enables QR to observe a higher KVS hit rate and outperform SemiData (assuming abundant memory).
With both BG and RAYS, refresh provides a higher performance than invalidation when a high percentage (10%) of the workload consists of writes. It serves stale data to realize its performance enhancements. With a low percentage of writes, invalidation is superior to eager because it is as fast while providing the application with consistent reads.
   A description of the BG benchmark is now presented. Subsequently, experimental results are presented.

TABLE 2
Four mixes of social networking actions with BG.

| | | Very Low | Low (1%) | High (10%) |
|---|---|---|---|---|
| BG Action | Read Only | (0.1%) Write | Write | Write |
| View Profile | 40% | 40% | 40% | 35% |
| List Friends | 5% | 5% | 5% | 5% |
| View Friends | 5% | 5% | 5% | 5% |
| Requests | | | | |
| Invite Friend | 0 | 0.02% | 0.2% | 2% |
| Accept Friend | 0 | 0.02% | 0.2% | 2% |
| Request | | | | |
| Reject Friend | 0 | 0.03% | 0.3% | 3% |
| Request | | | | |
| Thaw | 0 | 0.03% | 0.3% | 3% |
| Friendship | | | | |
| View Top-K | 40% | 40% | 40% | 35% |
| Resourses | | | | |
| View | 10% | 9.9% | 9% | 10% |
| Comments On | | | | |
| Resourse | | | | |

### BG Social Networking Benchmark

BG is a benchmark to quantify performance of a data store for interactive social networking actions and sessions. These actions and sessions either read or write a very small amount of the entire data set. In addition to response time and throughput, BG quantifies the amount of unpredictable data produced by a data store. This metric refers to either stale, inconsistent, or invalid data produced by a data store. This is particularly useful because it enabled us to experimentally verify the consistency claims of Section 3.

Table 2 shows the interactive actions of BG which are common to many social networking sites, see S. Barahmand and S. Ghandeharizadeh, “BG: A Benchmark to Interactive Social Networking Actions”, CIDR, January 2013. BG's database consists of a fixed number of members M with a registered profile. Its workload generator implements a closed simulation model with a fixed number of threads T. Each thread emulates a sequence of members performing actions in turn. BG establishes the SoAR (maximum throughput) and Socialites (maximum number of threads) ratings of different data stores to facilitate their comparison. In this study, BG's ratings schemeis not used. Instead, the throughput observed with a fixed number of threads is reported. A higher value of T causes BG to impose a higher load. This enables the tradeoffs associated with QR and SemiData in different settings to be described to provide insights in their behavior.

In the following experiments, BG constructs a database consisting of 10,000 members with 100 friends per member (100 is the median number of friends for a Facebook member, see J. Ugander, B. Karrer, L. Backstrom, and C. Marlow, “The Anatomy of the Facebook Social Graph”, CoRR, abs/1111.4503, 2011,) and 100 resources per member. BG emulates members as socialites using a Zipfian distribution with exponent 0.27. This means roughly 20% of the members perform actions of Table 2 as socialites. At an instance in time, T unique members will be performing actions simultaneously.

Table 2 shows four different workloads that were explored in this study. A read-only workload that performs no writes. A very low write workload with 0.1% of actions as writes. A low write workload with 1% of actions as writes. And, a high write workload with 10% of actions as writes. Typically, the workload of a social networking application is dominated by queries. Some are as high as 99.9%, see Z. Amsden, N. Bronson, G. Cabrera III, P. Chakka, P. Dimov, H. Ding, J. Ferris, A. Giardullo, J. Hoon, S. Kulkarni, N. Lawrence, M. Marchukov, D. Petrov, L. Puzar, and V. Venkataramani, “TAO: How Facebook Serves the Social Graph”, In SIGMOD, 2012.

All results reported below were obtained using two nodes with the following specifications: Windows Server 2003 R2 Enterprise x64 bit Edition Service Pack 1, Intel®Core™ i7-2600 CPU 3.4 GHz, 16 GB RAM, Seagate 7200 RPM 1.5 TB disk. The BG client executes on one node while a different node hosts the RDBMS and the SQLTrig server. These two nodes communicate using a 1 Gigabit Ethernet switch.

Comparison of RDBMS with QR and SemiData

FIG. 4 illustrates examples of throughput with four different workloads, M=10,000, T=100, with the BG benchmark. FIG. 4 shows the throughput of an industrial strength RDBMS, SQL-X, in stand alone mode and when extended with COSAR-SQLTrig in a CASQL deployment. The x-axis of FIG. 4 corresponds to four different BG workloads, see Table 2. In these experiments, QR is configured to perform invalidations. With a read only workload, SemiData and QR enhance the performance of SQL-X by more than a factor of 24 and 12, respectively. SemiData outperforms QR because it minimizes the number of KVS look ups. To elaborate, Table 3 shows the View Profile action of BG to consist of four SQL queries that retrieve (1) the profile attributes of a member such as her first name, last name, picture, etc., (2) her number of friends, (3) her number of pending friend invitations, and (4) her number of resources. With QR, each query is a KVS look up that incurs inter-processor communication. With SemiData, all four pieces of information are fused together as one value and associated with the key “Profile”+MID where MID is the identity of the member whose profile is being referenced. This minimizes the inter-processor communication, enabling SemiData to outperform QR by more than a factor of two.

Actions that write to the RDBMS (such as invite friend, and thaw friendship) invoke SQLTrig's authored triggers to invalidate cached key-value pairs. This causes read actions to observe a cache miss and be redirected to the RDBMS, slowing down SQLTrig (both QR and SemiData) as the percentage of write actions is increased. With 10% writes, the throughput of QR is 8 times higher than SQL-X whereas SemiData is 20 times higher. This is a four-fold reduction when compared with the read only workload.

TABLE 3
Size of key-value pairs produced by different BG actions.

| | Size of key-value pairs | | | | | |
|---|---|---|---|---|---|---|
| | | | QR: Custom | | QR: Java | |
| | SemiData | | Marshalling | | Marshalling | |
| BG Action | Uncompressed | Compressed | Uncompressed | Compressed | Uncompressed | Compressed |
| View Profile | 13,398 | 13,400 | — | — | — | — |
| Count of friends | — | — | 247 | 241 | 5,623 | 2,706 |
| Pending friend | — | — | 228 | 222 | 5,603 | 2,687 |
| invitation | | | | | | |
| Resource count | — | — | 212 | 206 | 5,588 | 2,671 |
| Profile detail with a | — | — | 13,640 | 13,479 | 19,691 | 16,498 |
| 12 KB image size | | | | | | |
| List 100 Friends | 297,069 | 276,380 | 288,801 | 258,126 | 316,030 | 279,718 |
| View Friends | 134 | 142 | 664 | 427 | 6,107 | 2,734 |
| View Top-5 | 2,088 | 1,292 | 2,048 | 1,382 | 8,477 | 4,271 |
| Resources | | | | | | |
| View Comments on | 133 | 141 | 345 | 251 | 5,457 | 2,507 |
| Resource (Empty) | | | | | | |

Table 3 shows SemiData produces key-value pairs that are more compact than QR. It also shows that the SQLTrig custom marshalling technique with QR outperforms the Java marshalling technique.

FIG. 5 shows an average response time of actions in a RAYS benchmark when using SQLTrig and SQL-X as a function of the percentage of write actions. Both SemiData and QR show a faster average response time than SQL-X under all workloads. For read only (0% write), SemiData is a factor of 75 faster than SQL-X. This decreases to a factor of 5 improvement when writes are 10% of the workload. QR has a more modest improvement (a factor of 5 to 6 faster average response time) over SQL-X but maintains a more steady response time as we increase the percentage of writes.

When the percentage of writes is low, 0% and 1%, SemiData out-performs QR by a factor of 14 and 7 respectively. However, when the workload consists of 10% writes, SemiData performs 17% worse than QR. QR is superior because it provides a higher cache hit rate than SemiData. With SemiData, an update to

SQL-X causes SQLTrig to invalidates a key-value pair that corresponds to the execution of several queries, in this case, 9 queries for a Browse session in the RAYS benchmark. This means all 9 queries must be re-computed in order to reconstruct the key-value pair that was invalidated. In contrast, QR only invalidates 1 out of the 9 queries. The other 8 queries that are unaffected by the update continue to be served from the KVS, enabling QR to outperform SemiData.

This phenomena with QR outperforming SemiData with 10% writes is dependent on the application workload and the design of key-value pairs. With the BG benchmark, SemiData out-performs QR with 10% writes because its key-value pairs are simpler. For example, BG's View Profile action issues 4 queries to construct a member's profile page. When member A accepts member B's friend invitation, this update invalidates 2 of the 4 queries used to compute A's profile: A's count of friend invitations and A's count of friends. This means QR provides 50% savings when compared with SemiData because SemiData requires the application to re-compute all 4 queries. With RAYS, QR provides more than 80% (8 out of 9) savings. This explains why the trend with RAYS is not observed with BG.

Comparison of Refresh with Invalidation

FIG. 6 illustrates an example of QR with refresh and invalidation, T=100, with the BG benchmark. FIG. 6 shows the throughput of QR configured with either refresh or invalidation technique, see above. Refresh outperforms invalidation by a higher percentage difference as the percentage of write actions is increased. With very low (0.1%) write, refresh is 5.7% better than invalidate. This enhancement increases to 22% with 10% write actions. Refresh achieves this higher performance by enabling SQLTrig to process key-value look ups using stale data while computing the new key-value pairs in the background. In-validate, on the other hand, deletes the impacted key-value pairs and redirects KVS misses to the SQL-X to compute updated key-value pairs and insert them in KVS. Query processing is slower than serving stale data using KVS look ups, explaining why refresh outperforms invalidation. In these experiments, 0.01%, 0.02% and 0.9% of reads with refresh were stale for the 0.1%, 1% and 10% write workloads, respectively. On the other hand, experiments with invalidation produced 0% stale reads for all the different write workloads. If an application tolerates stale reads, refresh provides a higher throughput.

### SQLTrig vs Application Specific Invalidation Code

A common folklore states that the use of triggers is slower than implementing invalidation code in the application software. Given SQLTrig depends on the use of triggers, this section evaluates this hypothesis by comparing SQLTrig with the following two alternative CASQL implementations:
SQL-X augmented with memcached version 1.4.2 (64 bit) using Whalin client version 2.5.1. The granularity of key-value pairs is identical to SQLTrig with SemiData. This implementation employs application consistency: the software developer performs global reasoning about the data and extends the software (implementation of BG's social actions) to invalidate key-value pairs in those methods that write to the database. For example, the method that enables one member to accept another's friend invitation is extended with additional software to compute the impacted keys and to issue memcached deletes to invalidate them.
Human authored triggers (HumanTrig) are registered with SQL-X to invalidate cached key-value pairs in the presence of changes to the database. The granularity of key-value pairs is identical to SQLTrig SemiData. The triggers are at the granularity of inserts, delete, and update to a table. However, there is no context for what social action (e.g., accept friend request) is the cause of the RDBMS update, forcing the developer to author the trigger to invalidate all possible impacted keys. This causes HumanTrig to delete more keys than necessary.

FIG. 7 illustrates an example comparison of COSAR-SQLTrig with memcached, M=10,000, T=100, with the BG benchmark. FIG. 7 presents the observed throughput with the alternative systems with two different BG workloads.

QR is included for comparison purposes. With 1% write actions, SQLTrig SemiData provides comparable performance to the application-tailored invalidation technique using memcached (less than 5% difference in all experiments). This implementation produces hundreds of stale reads (less than 0.02% of all reads) because memcached lacks the Gumball technique, see S. Ghandeharizadeh and J. Yap, “Gumball: A Race Condition Prevention Technique for Cache Augmented SQL Database Management Systems”, In ACM SIGMOD Workshop on Databases and Social Networks (DBSocial), 2012, see Property 5 of Section 3.

HumanTrig invalidates approximately twice as many keys when compared with memcached and SQLTrig SemiData due to insufficient context for the programmer to identify impacted keys precisely. The impact of this is not visible with 1% writes because deletes are infrequent. However, when we increase the frequency of writes to 10%, HumanTrig becomes significantly slower than both SemiData and memcached.

In sum, there is some truth to the folklore with HumanTrig due to lack of context to compute impacted keys precisely. However, with SQLTrig, the invalidations do not suffer the same limitation since the system maintains context based on issued queries and does not invalidate keys unnecessarily.

### Related Work

A key-value pair of CASQL shares similarities with a materialized view, MV, of a RDBMS. Both enhance the velocity of an application. However, their target applications are different. While MVs enhance the performance of applications that manipulate a large amount of data such as decision support applications and their On-Line Analytical Processing (OLAP) tools, key-values of a CASQL enhance the performance of interactive applications that retrieve a small amount of data from big data. An example of the latter is a query that retrieves the profile information of a member of a social networking site. A CASQL materializes millions (if not billions) of such query result sets as key-value pairs compared to a small number of (tens) of MVs crafted by a database administrator and indexed to process OLAP queries effectively. It is acceptable to delete a key-value pair because it corresponds to a small portion of the entire data set and fast to re-compute. However, the same may not be true for a MV due to its substantial size and significant time required to compute, materialize and index. A MV is incrementally updated, see A. Gupta and I. S. Mumick. “Maintenance of Materialized Views: Problems, Techniques, and Applications”, IEEE Data Eng. Bull., 18(2):3-18, 1995; K. Ross, D. Srivastava, and S. Sudarshan, “Materialized View Maintenance and Integrity Constraint Checking: Trading Space for Time”, In SIGMOD, May 1996; H. Mistry, P. Roy, S. Sudarshan, and K. Ramamritham, “Materialize View Selection and Maintenance Using Multi-Query Optimization”, In SIGMOD, May 2001, while a key-value might be updated, see P. Gupta, N. Zeldovich, and S. Madden, “A Trigger-Based Middleware Cache for ORMs”, In Middleware, 2011, invalidated, see A. lyengar and J. Challenger, “Improving Web Server Performance by Caching Dynamic Data”, In In Proceedings of the USENIX Symposium on Internet Technologies and Systems, pages 49-60, 1997; A. Labrinidis and N. Roussopoulos, “Exploring the Tradeoff Between Performance and Data Freshness in Database-Driven Web Servers”, The VLDB Journal, 2004; D. R. K. Ports, A. T. Clements, I. Zhang, S. Madden, and B. Liskov, “Transactional consistency and automatic management in an application data cache”, In OSDI. USENIX, October 2010, or refreshed, see J. Challenger, P. Dantzig, and A. Iyengar, “A Scalable System for Consistently Caching Dynamic Web Data”, In IEEE Computer and Communications Societies, 1999. We refer the interested reader to, S. Ghandeharizadeh and J. Yap. “Cache Augmented Database Management Systems”. ACM SIGMOD 2013 Workshop—DBSocial, June 2013, for a more comprehensive comparison of MVs with key-value pairs.

SQLTrig authors triggers to notify the KVS of a change in the result of a query instance that is the basis of a key-value pair. This resembles the query change notification mechanism of RDBMSs such as Oracle 11g and Microsoft SQL Server 2005 and its later editions. See, S. Ghandeharizadeh, J. Yap, and S. Barahmand “COSAR-CQN: An Application Transparent Approach to Cache Consistency”, In International Conference On Software Engineering and Data Engineering, 2012, we explores the use of this mechanism to maintain key-value pairs consistent with the database in the presence of RDBMS updates. This study shows today's industrial products either do not support notification for many (billions) query instances or slow down updates dramatically, providing service times in the order of minutes. SQLTrig is novel because it distinguishes between query templates and its instances, see Section 2. It limits the number of authored triggers based on query templates which is typically in the order of a few hundred for a given application. In the presence of RDBMS updates, SQLTrig authored triggers minimizing the number of messages from the RDBMS to the KVS by grouping all impacted query instances in one KVS delete (notification). With invalidation, SQLTrig deletes the impacted key-value pairs synchronously, enabling a transaction to observe its own update and to produce consistent reads. One may incorporate SQLTrig's translation process into an RDBMS to enable it to provide query change notification mechanism efficiently, see Section 7.

Early transparent cache consistency techniques invalidated cached entries at the granularity of either table change or combination of table and column change, see C. Amza, A. L. Cox, and W. Zwaenepoel, “A Comparative Evaluation of Transparent Scaling Techniques for Dynamic Content Servers”, In ICDE, 2005. These are suitable with web sites that disseminate information (e.g., stock market ticker prices, see A. Labrinidis and N. Roussopoulos, “Exploring the Tradeoff Between Performance and Data Freshness in Database-Driven Web Servers”, The VLDB Journal, 2004, results of Olympic events, see J. Challenger, P. Dantzig, and A. Iyengar, “A Scalable System for Consistently Caching Dynamic Web Data”, In IEEE Computer and Communications Societies, 1999, where a table is the basis of thousands of cached entries. They become inefficient with applications such as social networking where each row of a table is the basis of a different cached entry and there are many (billions of) rows and corresponding cache entries. With these techniques, an update to a row would invalidate many (billions of) cached key-value pairs even though only a single entry should be invalidated.

TxCache, see D. R. K. Ports, A. T. Clements, I. Zhang, S. Madden, and B. Liskov, “Transactional consistency and automatic management in an application data cache”, In OSDI. USENIX, October 2010, is a transparent caching framework that supports transactions with snap shot isolation. It is designed for RDBMSs that supports multi-version concurrency control, see P. Bernstein and N. Goodman, “Multiversion Concurrency Control—Theory and Algorithms”, ACM Transactions on Database Systems, 8:465-483, February 1983, e.g., PostgreSQL, and extends them to produce invalidation tags in the presence of updates. A generated tag is based on a query whose results is used to generate a cached key-value pair. The tag is for one attribute value of a table (TABLE:KEY). This works when the workload of an application consists of simple exact-match selection predicates. Details of how this technique works for queries with range and join predicates are not clear and its presented evaluation avoided join queries due to the severe performance impact. SQLTrig can be adapted to support such queries in TxCache, see Section 7. Moreover, SQLTrig can be used with all SQL RDBMSs that support triggers because it does not either modify or require a pre-specified concurrency control technique from the RDBMS.

CacheGenie, see P. Gupta, N. Zeldovich, and S. Madden, “A Trigger—Based Middleware Cache for ORMs”, In Middleware, 2011, employs an Object-Relational Mapping (ORM) framework such as Django to generate the SQL queries, object instances stored in the cache, and RDBMS triggers to invalidate cached objects. It can perform this for a subset of query patterns generated by the ORM. SQLTrig is different in three ways. First, SQLTrig generates triggers based on the issued SQL queries and not an ORM description. Thus, SQLTrig is applicable for use with both ORM(With an ORM framework, one employs QR by simply replacing the JDBC driver of the run-time system with SQLTrig's client that provides a JDBC interface) and non-ORM frameworks. Second, while CacheGenie caches the results of a query, SQLTrig supports both query result and semi structured data caching. Lastly, CacheGenie lacks support for range predicates. SQLTrig employs R-Trees to support range predicates.

### Embodiments

SQLTrig may be part of an RDBMS, a part of a client component of an RDBMS, a middleware (an ORM such as Hibernate) that sits in between an application and the client component of the RDBMS, and/or a component of an application.

FIG. 8 illustrates an example a system that includes an application server 801 containing an application 803 and an SQLTrig client 807, a relational database management system (RDBMS) 809, and a cache server 811. The application server 801 may execute application 803 which may issue SQL queries 805 to the SQLTrig client 807. The application 803 may be software that provides specific functionality. The SQLTrig client 807 may intercept the SQL queries 805 to author procedures and may be any of the types of SQLTrigs discussed above. The cache server 811 may include a key-value store that maintains different key-value pairs and deletes them in response to invalidation notifications from the RDBMS 809.

FIG. 9 illustrates a different system architecture that includes an application server 901 containing an application 902 and a JDBC wrapper 903, and a relational database management system (RDBMS) 904. The JDBC wrapper 903 may contain a cache 905 locally within the address space of the application server 901, a JDBC driver 906 that may facilitate querying the RDBMS 904, an SQLTrig module 907, and an Invalidation module 908. The application server 901 may execute an application 902 which may issue SQL queries to the JDBC wrapper 903. The SQLTrig module 907 may intercept the SQL queries to author procedures and may be any of the types of SQLTrigs discussed above. The local cache 905 may include a key-value store that maintains different key-value pairs. The Invalidation module 908 may receive invalidation notifications from the RDBMS 904 and may delete key-value pairs from the local cache 905.

### CONCLUSION

SQLTrig is a transparent consistency technique that maintains the key-value pairs of a CASQL solution consistent with their tabular representations in an RDBMS. In experiments with a social network benchmark, SQLTrig generated triggers proved faster than a human provided trigger because they utilize the structure of the SQL queries used to compute key-value pairs (instead of application semantics).

SQLTrig supports both query result (QR) and semi structured data (SemiData) caching. SemiData is superior to QR when the application's read to write ratio is high because its key-value pairs are coarser, corresponding to the execution of several SQL queries. With QR, if an application tolerates stale data, its refresh mode enhances system response time by requiring the cache server to compute a new value in the background and refresh the cache asynchronously.

SQLTrig may be extended to translate a wider variety of SQL queries (certain types of nested queries) into triggers. Alternative architectures may embody SQLTrig and its translation technique (see FIG. 1).

Unless otherwise indicated, the various functions and algorithms that have been discussed herein may be performed by a data processing system that is configured to perform these various functions and algorithms. The data processing system includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

The data processing system may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. An SQL query-to-procedure translation system for use in connection with a relational database management system (RDBMS) that is augmented by a cache and a cache management system that manages the cache, the query-to-procedure translation system comprising a data processing system that has at least one computer hardware processor and a configuration that, in response to a query issued by an application program for data from the relational database management system:
intercepts the query;
generates code that determines if data requested by the query that may be in the cache has changed; and
registers the code as a procedure with the RDBMS.

2. The SQL query to trigger translation system of claim 1 wherein the data processing system examines the query to determine whether it is of a form that is the same as a form of a previous query that resulted in the generation and registration of a trigger and, if so, does not generate or register an additional trigger.

3. The SQL query to trigger translation system of claim 1 wherein the data processing system, in response to the query:
generates code that determines if data requested by the query that is in the cache has changed since it was placed in the cache; and
registers the code as a trigger with the RDBMS.

4. The SQL query to trigger translation system of claim 1 wherein the query includes a join predicate.

5. The SQL query to trigger translation system of claim 1 wherein the query includes a selection predicate.

6. The SQL query to trigger translation system of claim 5 wherein the query includes a range selection predicate.

7. The SQL query to trigger translation system of claim 1 wherein the query includes multiple predicates.

8. The SQL query to trigger translation system of claim 1 wherein the query includes an aggregate function.

9. The SQL query to trigger translation system of claim 1 wherein the procedure is a trigger.

10. The SQL query to trigger translation system of claim 1 wherein the data processing system saves the procedure and, in response to an RDBMS DML, executes the procedure.

11. A non-transitory, tangible, computer-readable storage medium containing a program of instructions that causes a computer system running the program of instructions to:
intercept a query issued by an application program for data from a relational database management system (RDBMS) that is augmented by a cache and a cache management system that manages the cache; and
in response to the query:
generates code that determines if data requested by the query that may be in the cache has changed; and
registers the code as a procedure with the RDBMS.

12. The storage medium of claim 11 wherein the program of instructions causes the computer system running the program of instructions to examine the query to determine whether it is of a form that is the same as a form of a previous query that resulted in the generation and registration of a trigger and, if so, to not generate or register an additional trigger.

13. The SOL query to trigger translation system of claim 11 wherein the program of instructions that causes the computer system running the program of instructions to, in response to the query:
generate code that determines if data requested by the query that is in the cache has changed since it was placed in the cache; and
register the code as a trigger with the RDBMS.

14. The SOL query to trigger translation system of claim 11 wherein the query includes a join predicate.

15. The SOL query to trigger translation system of claim 11 wherein the query includes a selection predicate.

16. The SOL query to trigger translation system of claim 15 wherein the query includes a range selection predicate.

17. The SOL query to trigger translation system of claim 11 wherein the query includes multiple predicates.

18. The SOL query to trigger translation system of claim 11 wherein the query includes an aggregate function.

19. The SOL query to trigger translation system of claim 11 wherein the procedure is a trigger.

20. The SOL query to trigger translation system of claim 11 wherein the program of instructions causes the computer system running the program of instructions to save the procedure and, in response to an RDBMS DML, execute the procedure.
